(19) United States
(12) Patent Application Publication
(10) Pub. No.: US 2026/0244040 A1
(43) Pub. Date: Aug. 20, 2026

(54) ARTIFICIAL WAVEGUIDE, PHASE SHIFTER, COUPLER, SWITCHER, DELAY LINE AND RESONATOR

(71) Applicant: B.G. NEGEV TECHNOLOGIES AND APPLICATIONS LTD., AT BEN-GURION UNIVERSITY, Beer Sheva (IL)

(72) Inventor: Ron FOLMAN, Beer Sheva (IL)

(21) Appl. No.: 19/161,765

(22) PCT Filed: Mar. 5, 2024
(86) PCT No.: PCT/IL2024/050237

§ 371 Date: Sep. 3, 2025

Related U.S. Application Data
(60) Provisional application No. 63/450,017, filed on Mar. 5, 2023.

(51) Int. Cl. G02F 1/035

(52) U.S. Cl. CPC G02F 1/035

(57) ABSTRACT

A photonic circuit system is described. the photonic circuit system comprising at least one photonic layer formed of a material having selected electro-optic properties, and an arrangement of electrodes positioned on at least two opposite facets of the at least one photonic layer. In response to electric potential applied to one or more electrodes of the arrangement of electrodes, a refractive index varies in a respective region of the at least one photonic layer affected by the one or more electrodes, selectively defining shape and path of one or more photonic waveguides within the at least one photonic layer.

### TECHNOLOGICAL FIELD

The present disclosure relates to photonic circuits and specifically relates to controllable photonic circuits having selectively varying circuit arrangement and index of refraction.

### BACKGROUND

The demand for highly integrated photonic circuits continues to rise, posting greater challenges in developing high-fidelity high-density photonic chips. These challenges are further amplified in the context of photonic circuits for quantum applications, which operate at the single photon level.

To address this challenge, a great effort is being made to develop new techniques and materials suitable for use in photonic circuits and respective optical elements. Various such studies are focused on electro-optical properties of different materials, generally described by the Pockels effect, or Kerr effect, defining variation in refractive index of the material in response to external electric field. For example:
Ali K. Hamze, et al, Design rules for strong electro-optic materials, NPJ Computational Materials 6, 130 (2020).
Beskin et al, Growth and Structure of Strong Pockels Material Strontium Barium Niobate on SrTiO₃ and Si by Molecular Beam Epitaxy (2021). Adv. Photonics Res., 2: 2100111. https://doi.org/10.1002/adpr.202100111.
Valentin et al, Lead-Free Perovskite Thin Films with Tailored Pockels-Kerr Effects for Photonics (2023). ACS Applied Materials & Interfaces 15 (31), 38039-38048, DOI: 10.1021/acsami.3c06499.
Mian Zhang et al, Integrated lithium niobate electro-optic modulators: when performance meets scalability (2021). Optica 8, 652-667.
Agham B. Posadas et al, RF-sputtered Z-cut electro-optic barium titanate modulator on silicon photonic platform (2023). J. Appl. Phys. 134 (7): 073101.
K. Nashimoto et al., High-speed PLZT optical switches for burst and packet switching (2005). 2nd International Conference on Broadband Networks, Boston, MA, USA, 2005, pp. 1118-1123 Vol. 2, doi: 10.1109/ICBN.2005.1589732.
G. Chen, H.-L. Lin, J. D. Ng and A. J. Danner, Integrated Electro-Optic Modulator in Z-Cut Lithium Niobate Thin Film With Vertical Structure (2021). IEEE Photonics Technology Letters, vol. 33, no. 23, pp. 1285-1288, doi: 10.1109/LPT.2021.3114993.
A. Karvounis, F. Timpu, V. V. Vogler-Neuling, R. Savo, R. Grange, Barium Titanate Nanostructures and Thin Films for Photonics. Adv. Optical Mater. 2020, 8, 2001249.
Chengli Wang et al, Lithium tantalate electro-optical photonic integrated circuits for high volume manufacturing, arXiv:2306.16492.
Quack, N., Takabayashi, A. Y., Sattari, H. et al. Integrated silicon photonic MEMS. Microsyst Nanoeng 9, 27 (2023). https://doi.org/10.1038/s41378-023-00498-z.
Suraj, Shankar Kumar Selvaraja, Highly Oriented PZT Platform for Polarization-Independent Photonic Integrated Circuit and Enhanced Efficiency Electro-Optic Modulation, arXiv:2305.19126.
Li, Z., Wang, R. N., Lihachev, G. et al. High density lithium niobate photonic integrated circuits. Nat Commun 14, 4856 (2023). https://doi.org/10.1038/s41467-023-40502-8.
Xianwen Liu, Alexander W. Bruch, and Hong. X. Tang, “Aluminum nitride photonic integrated circuits: from piezo-optomechanics to nonlinear optics,” Adv. Opt. Photon. 15, 236-317 (2023).
Ma, X., Cai, Z., Zhuang, C. et al. Integrated microcavity electric field sensors using Pound-Drever-Hall detection. Nat Commun 15, 1386 (2024). https://doi.org/10.1038/s41467-024-45699-w.
Zhang, K., Sun, W., Chen, Y. et al. A power-efficient integrated lithium niobate electro-optic comb generator. Commun Phys 6, 17 (2023). https://doi.org/10.1038/s42005-023-01137-9.
Churaev, M., Wang, R. N., Riedhauser, A. et al. A heterogeneously integrated lithium niobate-on-silicon nitride photonic platform. Nat Commun 14, 3499 (2023). https://doi.org/10.1038/s41467-023-39047-7.
Li, M., Ling, J., He, Y. et al. Lithium niobate photonic-crystal electro-optic modulator. Nat Commun 11, 4123 (2020). https://doi.org/10.1038/s41467-020-17950-7.

Various publications relate to circular resonators and EO tunability, including the inventors' work, utilizing mode confinement by air on the outside, as in the conventional state-of-the-art:
M. Rosenblit, P. Horak, E. Fleminger, Y. Japha and R. Folman, Design of microcavity resonators for single-atom detection. J. Nanophoton. 1, 011670 (2007), Special issue.
M. Rosenblit, Y. Japha, P. Horak and R. Folman, Simultaneous optical trapping and detection of atoms by microdisk resonators. Phys. Rev. A 73, 063805 (2006).
M. Rosenblit, P. Horak, S. Helsby and R. Folman, Single-atom detection using whispering gallery modes of microdisk resonators, Phys. Rev. A 70, 053808 (2004).

Various materials and techniques are described in the literature, enabling electro-optical effects, and allowing integration in photonic and electro-optical circuits. These techniques utilize waveguides and electro-optical elements formed of Barium titanate (BTO), lithium niobate, Lead zirconate titanate (PLZT) and other materials having properties that give rise to significant Pockels coefficient values.

### GENERAL DESCRIPTION

Optical processing and photonic circuit can provide high-speed computing in classic and quantum regimes. Currently there are numerous obstacles. For example, a significant obstacle in utilizing photonic circuits relates to intensity loss due to light scattering. While this may be solved in certain classical photonic circuits using increased power, such loss provides limitation to quantum applications. Generally, even if a material is free from internal absorption, scattering of light is caused by edge roughness and internal geometrical defects that are typically associated with waveguide fabrication (e.g., electron or ion implantation creating defects), and due to bending losses associated with circuit geometry. Another obstacle in conventional photonic circuits is associated with control of the phase of the propagating light. This is so as typically, conventional waveguides are made of materials having limited to no electro-optical (EO) effect, e.g., made of Silicon Nitride (SiN), and phase shifting elements are typically achieved by heating waveguide regions. This technique has several drawbacks, such as chip heat load, long rise/fall times due to thermal capacity and conductivity of the materials and their surroundings, and significant cross talk. The latter drawback is associated with thermal conductivity of the waveguides and their surroundings, as heat is not a well-localized property. Alternatively, an effort is made for using EO materials combined with conventional waveguides, by placing the EO materials outside the waveguide so that it interacts with the evanescent field of the light mode. The fabrication of such systems requires complex efforts and provides only a small effect on most of the light mode. Another issue of the conventional waveguides and photonic circuits relates to the stability of the circuit against uncontrollable phase noise due to thermal and vibration noise. As indicated above, conventional waveguides are typically made of non-EO materials, resulting in limited ability to correct phase fluctuations with high bandwidth in real time. An additional problem in conventional circuits is the high fidelity which is required for high-end applications, such as AI accelerators or quantum information processing. This fidelity is typically hindered by fabrication imprecision (and the fact that circuit parameters are fixed by fabrication and cannot be dynamically altered). Another example of present-day drawbacks is the obstacle that has to do with the size of the elements or the photonic circuit itself. As standard elements, such as interferometers, require bending of waveguides, their size is large, inhibiting high-density circuits. Indeed, currently, photonic chips are made with a limited amount of elements.

Finally, as an additional example of current drawbacks, perhaps one of the biggest problems is the fixed nature of the present photonic circuits which are based on fixed fabricated elements. As the waveguides and other photonic elements are based on fixed fabricated elements, this limits variability (i.e., no programmability such as in an FPGA), limits correction of any variation due to manufacturing issues, and limits the ability to quickly react to thermal and vibration noise, as mentioned above.

A new generation of electro optical materials with sufficiently high Pockels coefficient enables for the first time to confine an optical mode solely due to the index of refraction difference created by the application of an electric field on the material. Namely, the applied electric field may define a waveguide without having air around the waveguide (or without physical fabrication to affect refractive index), thus not requiring any etching of the waveguide. The BTO is the first example of this new generation of materials and criteria for production of new materials having stronger Pockels effect are provided in the above reference publications. Accordingly, the photonics elements described here may already be utilized with BTO, and can be improved continuously in accordance with development roadmap indicated in Ali K. Hamze, et al, Design rules for strong electro-optic materials, incorporated herein by reference listed above. While BTO still has significant internal absorption and is suitable for photonic circuits with classical light (e.g. for AI accelerators), the new material roadmap will provide materials having lower absorption coefficients, becoming similar to the low absorption of the quartz crystal, and thus suitable for quantum optics applications. In some configurations also BTO may have a small absorption whereby a small frequency gap between absorption modes may enable narrow line width lasers to operate with low absorption. The techniques of the present disclosure may be utilized for BTO, or any other material having Pockels coefficient of 1000 pm/V or more.

Accordingly, the present disclosure provides a controllable and photonic circuit configuration, having controllable arrangement of waveguides that may include photonic processing gates/elements for quantum and non-quantum photonics, such photonic circuits are also referred to herein as Photonic Integrated Circuits (PIC). Accordingly, the present disclosure provides a photonic circuit, or PIC, comprising at least one photonic layer, formed of a selected material having selected suitable electro-optical properties, and an arrangement of electrodes arranged on at least one surface of the at least one photonic layer. The arrangement of electrodes may be positioned directly on the respective photonic layer or separated therefrom by a cladding layer having refractive index lower than that of the photonic layer. Due to electro-optical properties of the photonic layer, electric voltage applied on one or more selected electrodes of the electrode arrangement cause variation in the refractive index of regions of the photonic layer, directly associated with the one or more electrodes, generating one or more waveguides having geometry and path determined in accordance with the respective one or more electrodes.

In some embodiments, the use of an electrode arrangement configured to apply selected electric field onto one or more regions of at least one photonic layer, enables formation of a photonic circuit having one or more waveguide sections as well as additional optical/photonic elements such as phase shifter(s), coupler(s) splitter(s), switcher(s), delay line(s), and resonator(s), while eliminating the need for physical fabrication, such as etching or any other physical waveguides or optical fibers within the photonic circuit. More specifically, the photonic circuit may consist of a selected arrangement of waveguides and one or more other photonic elements, formed due to electric field applied onto the at least one photonic layer using an electrode arrangement. This reduced loss associated with scattering due to fabrication edge roughness, either from etching or deposition, as the edge roughness of metallic electrode is smaller, and in addition, as any roughness associated with the electric field falls exponentially with distance from the electrodes. Additionally, the technique of the present disclosure may provide reduced loss due to bending of the waveguides, because, as described in more detail further below, the present disclosure provides photonic circuit system enabling coupling and splitting in selected straight regions, and consequently also interferometry, using straight waveguides. Additionally, the present technique enables generating one or more waveguides forming a photonic circuit, and varying structure of the photonic circuit in accordance with electrodes' configuration and operation of selected electrodes.

In some embodiments, the photonic circuit may be associated with a control unit, configured to selectively apply electric voltage to selected electrodes of the electrode arrangement. An initial selection of electrodes to which electric voltage is applied generates an arrangement of waveguides defining a photonic circuit. Additionally, variation of electric voltage between the electrodes may vary arrangement of the photonic circuit, and/or vary operation of one or more photonic elements (e.g., logic gates, switches, etc.) of the photonic circuit to provide the desired operations of the circuit.

As noted, formation of the waveguides using electric field applied to the at least one photonic layer can provide controllable waveguide structures, while also eliminate, or at least significantly reduce, sharp variations or edge roughness that may scatter light. Additionally, the use of an electrode arrangement allowing variation in refractive index of selected regions of the photonic layer significantly reduce the need for bending of waveguides, and thus suppress bending losses. More specifically, the waveguides in the photonic circuit according to the present disclosure are formed by applying electric field on electro-optic material. The smooth nature of the electric field (especially at some distance from the electrodes) provides smooth edges as compared to waveguides fabricated by etching or material deposition. This reduces scattering within the photonic circuit, allowing the use of low signal operations, such as single photon operations suitable for quantum applications.

Further, the use of an electrode arrangement for forming waveguides, beam coupling and splitting elements and additional photonic elements of a photonic circuit, enables dynamic control over circuit operation for a fast change in selected configuration properties, as well as high bandwidth control of phase for circuit operation (e.g., control of interferometers) and feedback against thermal and vibrational noise. In some embodiments, the electrode arrangement may include selected electrodes (e.g., elongated and/or circular electrodes) having selected spatial shape for specific parts of desired photonic circuit. Such electrodes may be operated to apply electric field onto the respective regions of the photonic layer, thereby creating active waveguide in the selected region. In other times, selected electrodes may be held at ground voltage (or selected zero voltage) effectively turning off the respective waveguide.

In some embodiments, as described in more detail below, the electrode arrangement may comprise sets of electrodes that can form a waveguide section when operated together. Such electrode arrangement may enable creation of various selected configurations of waveguide forming together a photonic circuit. This configuration provides increased flexibility, where a photonic circuit system may be used for creating various arrangement of photonic circuits in accordance with different selected patterns of electrodes that apply electric field onto the at least one photonic layer.

In some embodiments, the whole photonic layer or one or more partial regions thereof, may be covered with point-like electrodes with inter-electrode gaps much smaller than the wavelength of light used in the photonic circuit system. Preferably, the electrodes are also much smaller that the wavelength of light used. Gap between the electrodes, and the electrodes size may be selected to increase smoothness of the electric potential and avoid light scattering. This configuration provides a photonic circuit system that can be completely altered in real time to realize numerous different configurations, similarly to configurable/programable electronic chips, FPGA.

Thus, according to a broad aspect, the present disclosure provides a photonic circuit system comprising at least one photonic layer formed of a material having selected electro-optic properties, and an arrangement of electrodes positioned on at least two opposite facets of the at least one photonic layer; in response to electric potential applied to one or more electrodes of the arrangement of electrodes, a refractive index varies in a respective region of the at least one photonic layer affected by the one or more electrodes, selectively defining shape and path of one or more photonic waveguides within the at least one photonic layer.

According to some embodiments, the electrode arrangement may comprise a first electrode located at a first surface of the at least one photonic layer, and an arrangement of a plurality of electrodes located at a second surface of the at least one photonic layer, said first electrode acts as a ground electrode.

According to some embodiments, the photonic circuit system may further comprise first, and second clad layers located at first and second surfaces of the at least one photonic layer between the at least one photonic layer and the electrode arrangement.

According to some embodiments, the electrode arrangement may comprise a plurality of electrodes comprising at least one elongated electrode defining at least one possible waveguide to be activated in response to applied electric voltage on the at least one elongated electrode.

According to some embodiments, the electrode arrangement may comprise at least one coupling/splitting sub-arrangement comprising three or more groups of one or more electrodes, wherein a first and a second groups of electrodes define first and second waveguides in response to electric voltage applied thereto, and a middle group of one or more electrode of the coupling/splitting sub-arrangement defines coupling between the first and second waveguides in response to electric potential applied thereto, thereby generating a selectively variable optical element.

According to some embodiments, the at least one coupling/splitting sub-arrangement may be operable for at least one of coupling, splitting, and switching transmission of optical signals within a photonic circuit.

According to some embodiments, the electrode arrangement may comprise at least one phase affecting sub-arrangement comprising two or more electrodes positioned to affect refractive index within a common region of the at least one photonic layer; said two or more electrodes comprise a main group of one or more electrodes defining a waveguide within the at least one photonic layer in response to electric voltage applied thereto, and at least one secondary electrode affecting refractive index within the waveguide in response to electric voltage applied thereto, thereby selectively affecting phase accumulated by light passing through the waveguide.

According to some embodiments, the electrode arrangement may comprise at least one set of electrodes configured to define a resonator waveguide portion.

According to some embodiments, the at least one set of electrodes configured to define a resonator waveguide portion may comprise one or more electrodes defining a circular resonator waveguide or a straight resonator waveguide.

According to some embodiments, the at least one set of electrodes configured to define a resonator waveguide portion comprise a straight waveguide electrode portion and two or more electrodes configured to vary refractive index at two ends of the straight waveguide electrode portion, thereby defining a straight waveguide portion with Bragg mirrors at each side forming a Fabry-Perot resonator.

According to some embodiments, the electrode arrangement may comprise at least one set of electrodes arranged to define a bent waveguide portion (e.g., in the form of a spiral). Such bent waveguide portion may be operable as a delay line within a photonic circuit.

According to some embodiments, the electrode arrangement may comprise a plurality of independently controlled point-like electrodes positioned on at least one facet of the at least one photonic layer, and wherein applying electric voltage to a set of point-like electrodes along a selected region defines a waveguide within respective region of the at least one photonic layer.

According to some embodiments, the selected electro-optic properties comprise Pockels coefficient defining refractive index variation in response to DC electric field.

According to some embodiments, the at least one photonic layer comprises a material having at least one Pockels coefficient exceeding 1000 pm/V.

According to some embodiments, the at least one photonic layer is formed of BTO (BaTiO3).

According to some embodiments, the photonic circuit system may further comprise a control unit comprising at least one processor and memory circuitry, the control unit is electrically connected to electrodes of the electrode arrangement and configured to selectively apply electric voltage to selected electrodes in accordance with desired photonic circuit layout and operation.

According to some embodiments, the electrode arrangement may comprise electrodes formed of transparent electrically conducting material. For example, such transparent electrodes may be formed of Indium tin oxide (ITO) or any other transparent electrically conducting material.

According to some embodiments, the electrode arrangement may comprise metallic electrodes, wherein the metallic electrodes are sufficiently thin to eliminate absorbing of light by the metallic electrodes. For example, the metallic thin electrodes may have thickness of tens of nanometers or below.

According to some embodiments, the electrode arrangement comprises crystalline electrodes. For example, the crystalline electrodes may be formed of graphene.

According to one other broad aspect, the present disclosure provides a method for forming a controllable photonic circuit, the method comprising:
(a) providing at least one photonic layer formed of material having selected electro-optical properties;
(b) applying an electrode arrangement formed of a plurality of electrodes having selected pattern to generate electric field affecting the at least one photonic layer from at least one surface of the at least one photonic layer;
(c) providing electric voltage to one or more selected electrodes of the electrode arrangement, such that the one or more electrodes apply electric field onto respective regions of the at least one photonic layer, thereby defining a selected waveguide arrangement within the at least one photonic layer.

According to some embodiments, the method may further comprise selectively varying electric voltage on one or more selected electrodes for controllably varying coupling between waveguides defined by the waveguide arrangement.

According to some embodiments, the method may further comprise applying a cladding layer on both sides of the at least one photonic layer and applying the electrodes on the cladding layer.

According to some embodiments, applying the electrode arrangement may comprise providing at least one common ground electrode at a first side of the at least one photonic layer and providing an electrode arrangement comprising a plurality of electrodes defining one or more possible photonic circuits at a second side of the at least one photonic layer.

According to some embodiments, the electrode arrangement may comprise a plurality of independently controlled point-like electrodes, wherein applying electric voltage to a set of point-like electrodes along a selected region defines a waveguide within respective region of the at least one photonic layer.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates schematically a photonic circuit system according to some embodiments of the present disclosure;

FIG. 2 illustrates schematically an additional photonic circuit system utilizing clad layers according to some embodiments of the present disclosure;

FIG. 3 shows the Pockels coefficients of several materials having meaningful electro optic response;

FIG. 4 shows Comsol simulation of an optical mode supported by a BTO waveguide formed according to some embodiments of the present disclosure;

FIG. 5 illustrates a side view of a section of a photonic circuit system according to some embodiments of the present disclosure, and exemplifying waveguide formation in the circuit;

FIGS. 6A to 6C exemplify phase affecting gates suitable for use in a photonic circuit system according to some embodiments of the present disclosure, FIG. 6A exemplifies additional electrode configuration, FIG. 6B exemplifies waveguide section configuration, and FIG. 6C exemplifies patch electrode configuration;

FIGS. 7A to 7D exemplify simplification of a photonic circuit section using the technique of the present disclosure, FIG. 7A exemplifies a conventional photonic circuit section, and FIG. 7B exemplifies similar circuit configured by electrodes according to some embodiments of the present disclosure, eliminating a need for bending of the waveguides, FIGS. 7C and 7D show simulation of coupling being turned off in FIG. 7C and turned on in FIG. 7D resulting in light transfer to a second waveguide by controlling the tunneling (coupling) rate using a third electrode in between the two waveguides.

FIG. 8 exemplifies a photonic circuit section configured according to some embodiments of the present disclosure;

FIG. 9 exemplifies a ring resonator coupled to a waveguide configured according to some embodiments of the present disclosure; and

FIG. 10 exemplifies a pixel-like electrode configuration providing configurable photonic circuit system according to some embodiments of the present disclosure.

### DETAILED DESCRIPTION OF EMBODIMENTS

As indicated above, the present disclosure provides a photonic circuit system, suitable for various photonic processing and communication, as well as quantum photonics. The Photonic circuit system of the present disclosure is based on at least one photonic layer, also referred to as active substrate layer (ASL), formed of a material having selected electro-optic properties, and an electrode arrangement positioned and operable for applying electric field on to selected regions of the photonic layer.

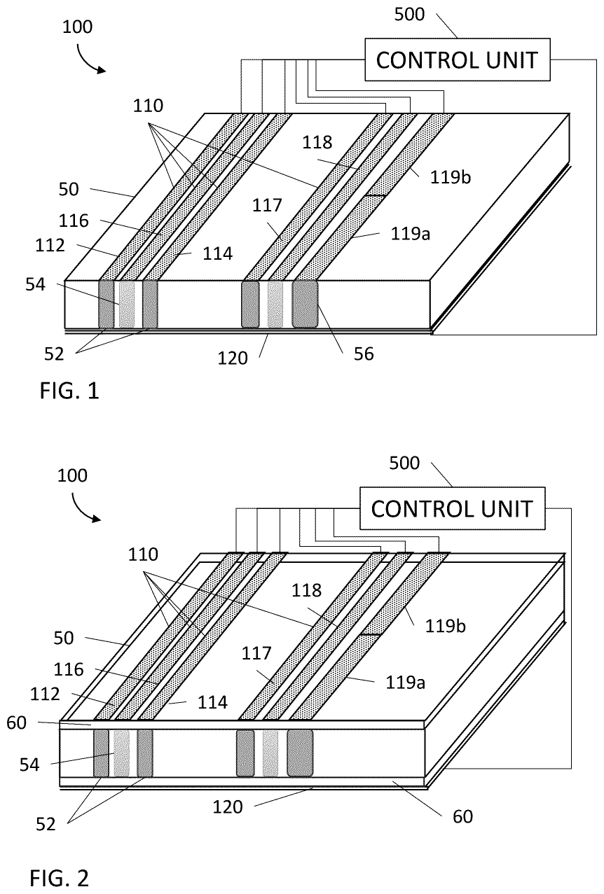

Reference is made to FIG. 1 schematically illustrating a photonic circuit system 100 according to some embodiments of the present disclosure. The system 100 includes at least one photonic layer 50, and as electrode arrangement 110 positioned on facets of the photonic layer 50. FIG. 1 illustrates top electrode arrangement 110, which in this non-limiting example includes electrodes 112, 114, 116, 117, 118, 119a and 119b, and bottom electrode 120. Generally, bottom electrode 120 may be used as a common electrode, electrically conductive substrate, or it may be formed as an additional electrode arrangement having a plurality of electrode portions mirroring arrangement of the electrodes on a top facet of the photonic layer 50. When used as a common bottom electrode or electrically conductive substrate, bottom electrode 120 may be held at ground potential. It should be understood, and is described in more detail below, that arrangement of the electrodes may vary in accordance with desired layout of the photonic circuit. Further, as described below, the arrangement of the electrodes may support multiple possible photonic circuit layouts in accordance with operation of the electrodes.

The electrodes of the electrode arrangement 110 may be operably connected to a control unit 500 configured to selectively apply electric voltage to selected electrodes, in accordance with desired waveguide arrangement of a photonic circuit. Control unit 500 may include one or more processor and memory circuitries (PMCs) and input/output interface. Additionally control unit 500 may include an electronic circuit configured to apply selected electrical voltage to selected electrodes of the electrode arrangement 110. Generally, the one or more PMCs of control unit may be operable in accordance with selected input and/or pre-stored data, to operate the electronic circuit for applying selected electric voltage to selected electrodes of electrode arrangement 110, thereby forming and operating a selected photonic circuit within the at least one photonic layer 50.

When operated, the control unit 500 may utilize an electronic circuit thereof to generate selected electric voltage difference between selected electrodes, applying selected electric field on regions of the photonic layer 50. For example, voltage difference between electrodes 112 and 120, and 114 and 120 generates electric field in the regions between the electrodes forming waveguides 52. A different electric potential may be applied between electrodes 116 and 120, generating waveguide 54 in the region between the electrodes. Such waveguide 54 may be used to apply phase shift to light passing through it, with respect to light passing through waveguides 52. Alternatively, or additionally, waveguide region 54 may be used to promote coupling of light between the two waveguides 52, by increasing the refractive index in a region between the waveguides and thus increasing coupling between the waveguides 52.

Additionally, as exemplified, a waveguide may be formed by two or more electrodes, such as electrodes 119a and 119b. These electrodes are separated from each other. However, when operated to maintain similar electric voltage, the electrodes 119a and 119b form together a common, elongated waveguide 56. The separation between the electrodes preferably keeps the electrodes 119a and 119b electrically insulated between them, with a distance that is generally smaller than a distance between the electrodes and the mode supported by waveguide 56, to maintain continuous waveguide, or smaller than wavelength of optical radiation used within the waveguide 56.

Although the waveguides 52 and/or 54 are formed within the photonic layer, i.e., in regions where the refractive index varies based on electric field, modes of light passing through the waveguides may extend beyond the photonic layer 50. To prevent absorption of light by the electrodes of the electrode arrangement 110, the electrodes may be formed of materials selected to suppress absorption. For example, the electrodes may be formed of crystalline material with absorption peaks distant from wavelength of light propagating in the waveguides. In some other embodiments, the electrodes may be formed of transparent electrically conducting material such as Indium Tin Oxide (ITO), or formed of thin metal layers, e.g., having thickness in the range of tens of nanometers, making the electrodes effectively transparent.

In some further embodiments, e.g., as illustrated in FIG. 2 the photonic circuit system may utilize clad layers 60 located on two facets of the photonic layer 50, between the photonic layer 50 and the electrodes 110. The clad layer 60 distances the electrodes from the optical modes of the waveguides 52. This configuration may allow the use of various types of electrodes 110. This is partly due to the fact that the use of clad layers 60 generates distance between the electrodes of electrode arrangement 110 and the photonic layer 50, resulting in reduced interaction/absorption between the optical modes of the waveguide and the electrodes. Additionally, the use of clad layers makes the electric field at the photonic layer act as far field, thus further eliminating sharp field variations due to corners or edges of the electrodes. The use of clad layers 60 also provides for distancing the electrodes from light modes supported by the waveguides, allowing various combinations of two or more electrodes to be operated together and form a common waveguide, as in the example of electrodes 119a and 119b. This enables the electrode arrangement to include point-like, or pixel, electrodes that may be operated together to generate various spatial formations of photonic circuits, as described in more detail below.

As indicated above, the at least one photonic layer 50 is formed of a material having selected electro-optic properties. More specifically, the photonic layer 50 may be formed of a material having selected, and sufficiently high, Pockels coefficient, being second order electric susceptibility χ⁽²⁾. Pockels coefficients indicate level of Pockels effects, or DC Kerr effect in the material, where electric field applied on the material causes variation in refractive index of the material.

Generally, the Pockels effect is an electro-optic effect in which the refractive index of an optical medium can be changed by applying an electric field on the medium. Pockels effects is generally a linear electro-optic effect, where the change in refractive index (Δn) is directly proportional to the strength of the electric field (E) applied on the medium. This effect generally occurs in crystals that lack inversion symmetry, such as the materials listed above. Although Pockels coefficients measured for most known materials are very small, various materials such as Barium titanate (BaTiO3 or BTO) exhibit a relatively large Pockels effect, characterized by stress free Pockels coefficient of r₄₂≈1300±100 pm/V. Ongoing research is done for developing additional materials having increased Pockels effect. Generally, the technique of the present disclosure may utilize materials having Pockels coefficients of 1000 pm/V or higher.

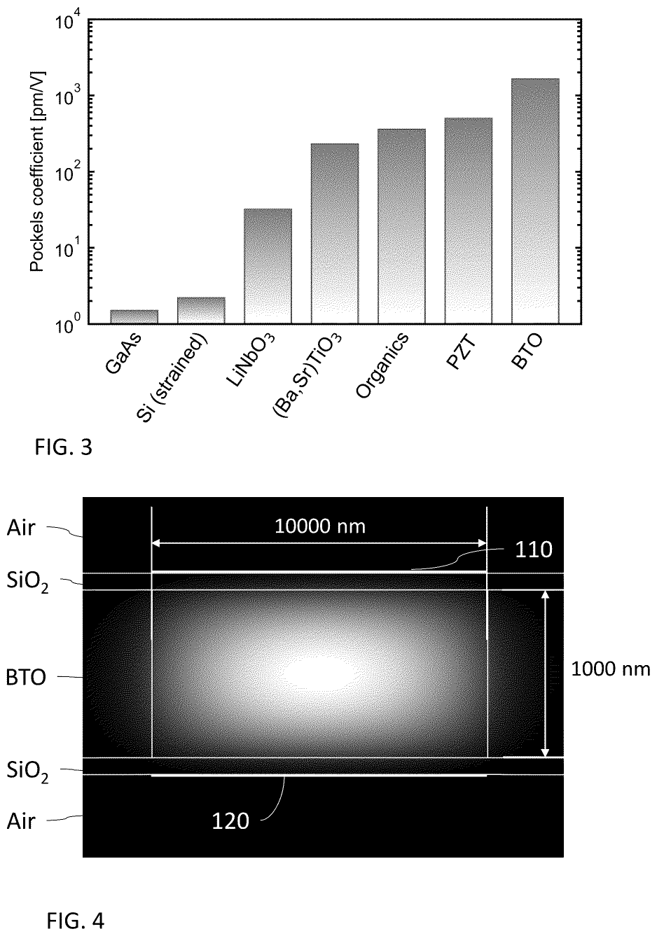

The Pockels effect stems from the behavior of the electric polarization which in a non-linear medium can be expressed as a power series of the electric field E. The higher order terms are the source of the variation of the dielectric constant (also associated with the refractive index) as a function of external electric field applied onto the material. In particular the quadratic term, χ⁽²⁾_{i,j,k}EⱼEₖ induces the Pockels effect. The Pockels coefficients depend on the direction. They are generally different for the three principal axes of the lattice structure of the medium. FIG. 3 shows Pockels coefficients for a few selected materials manifesting relatively high electro-optic properties. As shown, certain materials such as Gallium Arsenide (GaAs) and Silicon (Si) show minimal response to electric field. This is while other materials such as Lithium niobate (LiNbO3), Lead zirconate titanate (PZT) and various organic compounds show increased electro optic properties. The currently known champion in this field is Barium titanate (BTO) having stress free Pockels coefficient of ~1300 pm/V. It should be noted that the technique of the present disclosure is not limited to the use of a specific material and relates in general to the use of Pockels effect, and material having Pockels coefficient exceeding 1000 pm/V. Such materials including, e.g., BTO, may be used for the at least one photonic layer of the photonic circuit system described herein.

Additionally, FIG. 4 exemplifies dimensions of an optical mode in a BTO photonic layer used according to some embodiments of the present disclosure. FIG. 4 exemplifies a BTO photonic layer having thickness of 1000 nm. The photonic layer is placed on clad layers formed of SiO₂ followed by air environment. Generally, BTO has a refractive index of n=2.4, and SiO₂ has a refractive index of n=1.46 at wavelength of 550 nm, or 1.4585 at wavelength of 1550 nm. In this simulated example, electrodes 110 and 120 are held in voltage difference of 1V between them, generating an electric field of 10⁶ V/m in a direction between the electrodes. Due to the electric field, the refractive index in the region between the electrodes changes by Δn=0.005 following Pockels coefficient of r₄₂=1300±100 pm/V for wavelength of 1550 nm. Data on the optical and electro-optical properties is well known and can be found for example in A. Karvounis et al, Barium Titanate Nanostructures and Thin Films for Photonics. Adv. Optical Mater. 2020, 8, 2001249. As exemplified in FIG. 4, to support an optical mode, the waveguide may be formed with width of 10000 nm (or 10 microns).

These results illustrate the ability to maintain waveguides and stable modes within BTO using applied voltage within limits of 10⁶ V/m electric field, which prevents spontaneous discharge (typical limit stands at 10⁷ V/m). Furthermore, using a photonic layer having of 1 μm thickness, and electrodes wielding 10 μm wide waveguides can provide flexible photonic circuits for various applications.

Reference is now made to FIG. 5 exemplifying a cross-section view of a portion of a photonic circuit system 100 according to some embodiments of the present disclosure. As shown, the photonic circuit system 100 includes at least one photonic layer 50, formed of a material having selected electro-optic properties. The photonic layer 50 may be sandwiched by clad layers 60. Additionally, the photonic circuit system 100 includes top electrode arrangement 110 and bottom electrodes 120. In this example, top electrode arrangement includes electrodes 112, 114 and 116, and bottom electrodes 120 includes two separate electrodes, one is aligned with electrode 112 and the other is aligned with electrodes 114 and 116. Generally, the bottom electrodes 120 may be grounded, while an electric voltage may be applied to selected top electrodes 110.

The clad layer 60 is formed of a selected material having refractive index lower than that of the photonic layer 50. When applying electric voltage between selected electrodes, e.g., electrodes 112 and 120, the electric field between the electrodes varies the refractive index of the photonic layer 50, and generates one or more waveguides, e.g., waveguide 52. More specifically, given that the photonic layer 50 is aligned such that the electric field affects the proper axis (e.g., the ordinary axis) of the photonic layer 50, the refractive index in the region between the electrodes increases and reach the value n₁ which is larger than n₂, the refractive index in the region outside the electrodes, and n₃ the refractive index of the clad layer 60, i.e., n₁>n₂>n₃. This variation in the refractive index in the region between the electrodes yields a waveguide 52 in the region. A similar effect may be provided by applying electric voltage between electrodes 114 and 120, or electrodes 116 and 120, generating corresponding waveguides. Generally, by applying selected different electric voltages, refractive indices of different waveguides may be different, generating relative phase difference to light propagating within the different waveguides. Additionally, as described further below, selected electric voltage between the electrodes may be used to promote coupling of light between separate waveguides.

Generally, due to the anisotropy of the Pockels effect, the variation of the refractive index of the photonic layer 50 depends on its orientation with respect to the electrodes. More specifically, in some materials, while the refractive index of the ordinary axis no goes up with electric field, the refractive index along the extraordinary axis ne goes down with electric field. Accordingly, it should be understood that the photonic circuit system described herein may be operated by orienting the field along either of these axes. For an orientation along the extraordinary axis, the waveguide is formed outside the electrode region.

Furthermore, some organic and polymeric materials exhibit the Pockels effect. Such materials may be advantageously used to provide a photonic layer according to some embodiments of the present disclosure. For example, manufacturing of the at least one photonic layer 50 using organic or polymeric materials may be easier over crystalline materials.

Generally, as described above, the present disclosure provides a photonic circuit system, where waveguides of a photonic circuit are formed based on electric field applied on at least one photonic layer using an electrode arrangement. The use of electric field for affecting the refractive index of the photonic layer enables simplification of a photonic circuit and provides various photonic elements affecting optical signals transmission through the photonic circuit.

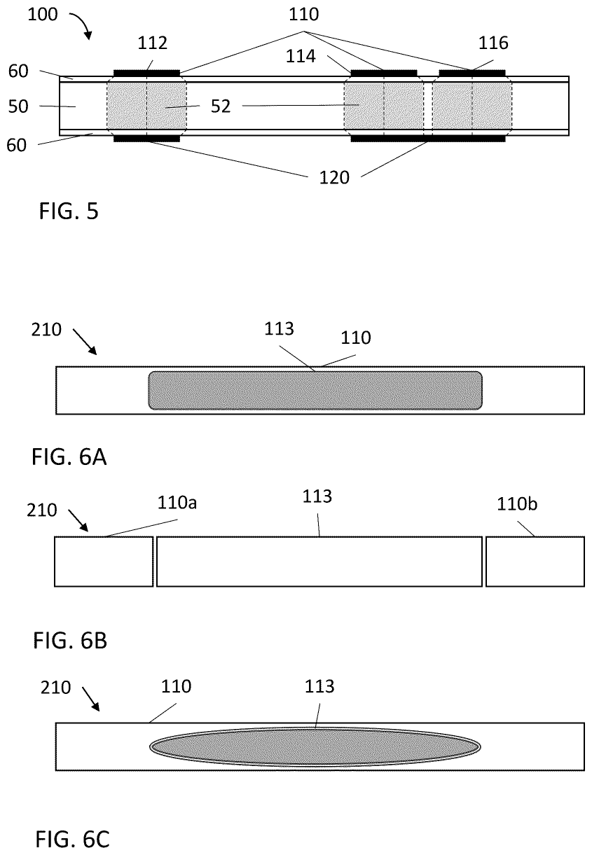

For example, FIGS. 6A to 6C exemplify three configurations for a phase affecting photonic element 210. The phase affecting photonic element 210 is a region along a waveguide 110, where the phase of an optical signal is affected by varying the optical path of the signal through the waveguide. In FIG. 6A the phase affecting element 210 is formed by an additional electrode 113 positioned on top or below the electrode 110, while being electrically insulated therefrom. The additional electrode 113 may be selectively held at a selected electric voltage, generating additional electric field, over that generated by electrode 110. The additional electric field further increases or decreases the refractive index of the region under electrode 113, causing change in phase accumulated by the light passing through the element 210.

FIG. 6B exemplifies an additional phase element 210 configuration. In the example of FIG. 6B, electrodes 110a and 110b form a waveguide with a discontinuity along the desired waveguide path, and an additional electrode 113 is located in the gap. The additional electrode 113 may be operable using similar electric voltage as electrodes 110a and 110b, providing a continuous waveguide, without any phase affecting region. Alternatively, the additional electrode 113 may be operated with a slightly different electric voltage, causing a small variation in refractive index in the region associated with the additional electrode 113. Signals propagating through the waveguide will experience a slightly different optical path and accumulate a selected phase variation with respect to signals passing through similar length of waveguide. Generally, in this configuration, electrodes 110a and 110b may also be operated in different electric voltages, affecting the waveguide refractive index for various other applications. It should be noted that the gap between the electrodes is preferably smaller than the wavelength of light, and smaller than the distance of the light mode to the electrodes, so that the light is not affected by the discontinuity.

The example of FIG. 6C utilizes an electrode 110 having a hole, or region of discontinuity, while the edges of the electrode 110 provide a continuous connection along the electrode. An additional electrode 130 is located within the discontinuous region, being electrically insulated from electrode 110. Similarly, to the example of FIG. 6B, the additional electrode 113 may be operated with similar electric voltage as electrode 110 to provide a continuous waveguide, without any phase affecting region. Alternatively, electrode 113 may be operated with electric voltage different than that of electrode 110, reducing or increasing the refractive index in the waveguide region under the additional electrode 113, thereby varying the phase accumulated by the signals transmitted through the waveguide. Similarly, the insulating gap between the electrode portions is preferably smaller than the wavelength of light and smaller than the distance of the light mode to the electrodes.

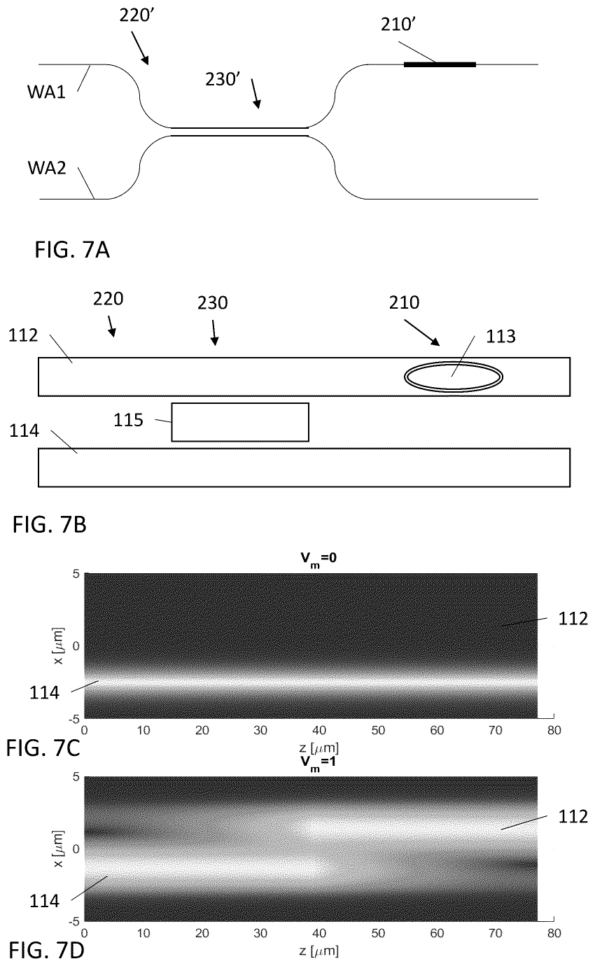

Furthermore, FIGS. 7A and 7B exemplify a section 220′ of a photonic circuit configured using conventional waveguides and/or optical fibers in FIG. 7A, and a corresponding configuration of a similar photonic circuit section configured according to some embodiments of the present disclosure in FIG. 7B. Additionally, FIGS. 7C and 7D exemplify the simulated coupling between the waveguides turned on or off using coupling electrode 115. FIG. 7A exemplifies a circuit section 220′ including coupling 230′ between two input waveguides WA1 and WA2, followed by a phase affecting element 210′ operating on WA1. FIG. 7B illustrates a similar photonic circuit section 220 including a first and a second waveguides 112 and 114. To provide coupling between the first 112 and the second 114 waveguides, a coupling electrode 115 is located between the electrodes forming waveguides 112 and 114. When the coupling electrode 115 is operated to be charged by a selected electric voltage, electrode 115 (and corresponding electrode located on other side of the photonic layer) applies electric field on a respective region of the photonic layer 50, increasing the refractive index in the corresponding region of the photonic layer, and thus increasing coupling between waveguides formed by electrodes 112 and 114. Additionally, similarly to the circuit configuration 220′ of FIG. 7A, circuit 220 of FIG. 7B also includes a phase element 210, using an additional electrode 113 located along the waveguide formed by electrode 112. In this example, the phase element 210 is configured similarly to the example of FIG. 6C, however, any one of the exemplary configurations of FIGS. 6A to 6C may be used.

FIGS. 7C and 7D show a simulation of light passing through a waveguide 114 formed according to embodiments of the present disclosure, in a photonic circuit section configured as exemplifying in FIG. 7B. In FIG. 7C, coupling electrode 115 is kept at neutral electric voltage, turning off coupling between waveguides 112 and 114. In FIG. 7D, coupling electrode 115 is operated with an electric voltage similar to that defining electrodes 112 and 114. This provides an increase in the refractive index within the space between the waveguides that results in coupling between waveguides 112 and 114. As shown in FIG. 7D, due to the coupling, the optical signal shifts from the bottom waveguide 114 to the top waveguide 112. Also, as shown in FIG. 7D, due to operation of coupling electrode 115, waveguides 112 and 114 act together as a wide waveguide supporting two or more modes including side modes. The coupling level (e.g., voltage on coupling electrode) and the length of the active coupling electrode may be used to determine a ratio of signal intensity that is transmitted between the waveguides, and to provide variable coupling or a selected level of splitting between the waveguides. It should be understood that an electric voltage level applied by coupling electrode 115 may be similar to that applied by the waveguide electrodes 112 and 114, or lower. The electric voltage applied on coupling electrode 115 may determine transition length, in which an optical signal fully shifts between the waveguides. This enables shifting between complete transmission of the signal and/or splitting of a signal between the waveguides at any selected ratio. In the case simulated here, the mode is completely transferred due to interference.

As further exemplified in FIGS. 7A and 7B, the technique and the photonic circuit configuration of the present disclosure each provides several advantages over conventional photonic circuit configurations. As shown in FIG. 7B, the coupling between waveguides can be controlled by a coupling electrode 115, providing selectively controllable coupling. This allows operation of the photonic circuit in various modes, including dynamic variation of coupling between the waveguides. Further, applying a selected electric voltage on coupling electrode 115 may increase or reduce coupling between the waveguides. Additionally, the use of controlled coupling obviates the need for bending of the waveguides, which may cause loss and scattering of light. Additionally, due to eliminating the need for bending, similar photonic circuit may utilize smaller area allowing to form additional photonic elements within a similar form factor.

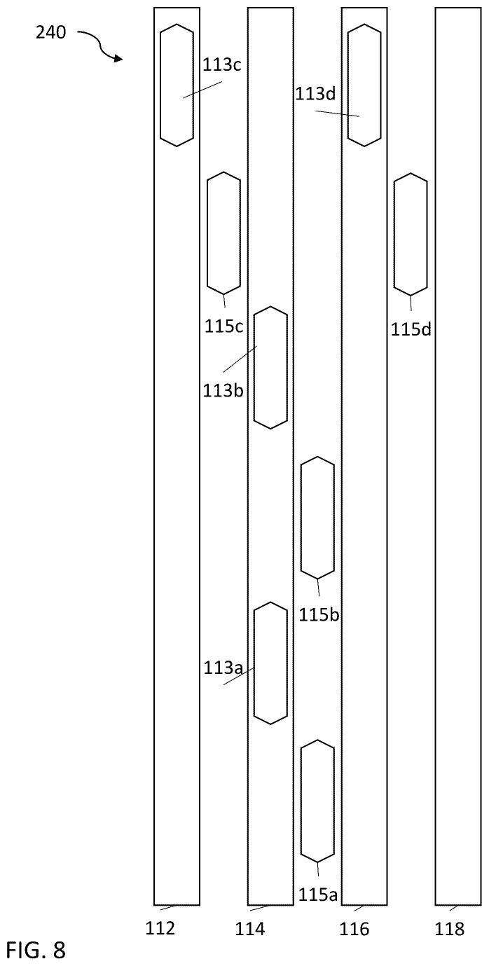

Furthermore, FIG. 8 exemplifies a larger photonic circuit portion 240. In this example, the photonic circuit section 240 is based on four waveguides 112, 114, 116 and 118 and selected coupling regions 115a to 115d and phase affecting elements 113a to 113d along the waveguides. As described above, the waveguides are formed by applying electric voltage on the electrodes arrangement and require no etching of the photonic layer and/or clad layers. Additionally, coupling and phase affecting elements are formed by electrodes of the electrode arrangement and may be turned on or off and modulated by applying selected electric voltage thereon. Accordingly, in selected circuits, coupling electrodes 115a and 115d may be turned off, to avoid coupling between the respective waveguides, while coupling electrodes 115b and 115c may be operated with selected electric voltage to provide selected coupling between the waveguides. Similarly, selected phase affecting electrodes 113a to 113d may be turned on or off, and create selected phase, determined by electric voltage applied thereto, and length of the phase affecting electrodes.

Generally, and arrangement of one or more photonic elements, e.g., as exemplified in FIG. 8, may be used together to form various other photonic elements. For example, an arrangement of two coupling elements may be used to provide an interferometric element, providing interference between two optical signals. An additional phase affecting element, varying phase of either one of the input signals, and/or the output interference signal, may be used to provide a variable switch. Using controlled phase variation of the phase element enables control of output signal through any one of two output waveguides of the interferometer arrangement with any selected intensity.

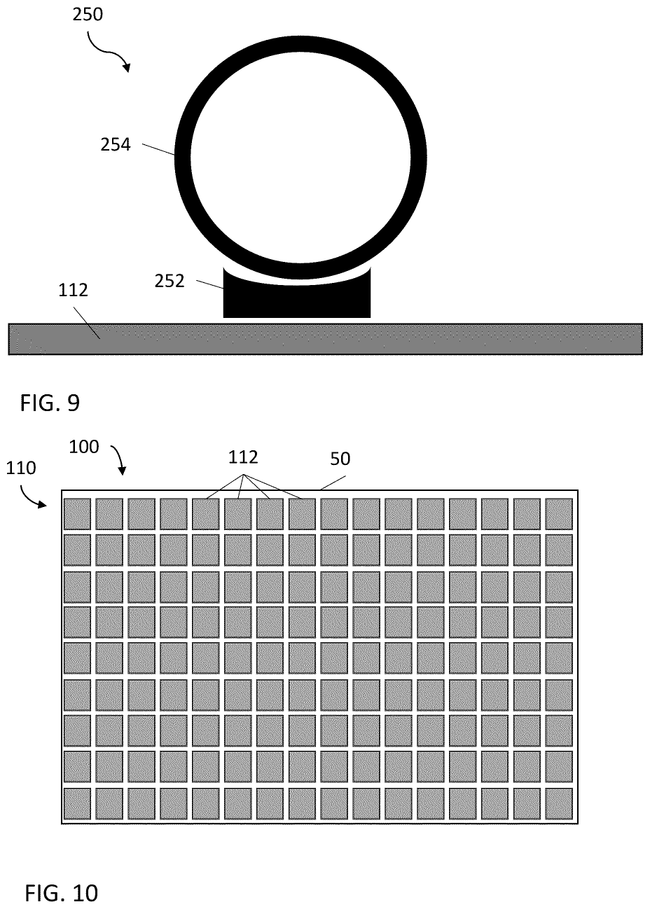

Reference is made to FIG. 9 illustrating an exemplary configuration of an optical resonator 250 according to some embodiments of the present disclosure. As shown, a waveguide electrode 112 may be operated to define a respective waveguide within the photonic layer. The resonator unit may be defined by a circular electrode 254, which when operated to hold selected electric voltage, can define a corresponding circular waveguide within the photonic layer. Although most circular resonators (so-called micro-ring, or micro-disk, or toroid resonator) do not make use of a coupling control, as exemplified in the above listed references by the inventor relating to circular resonators, a coupling electrode 252 may be placed between the waveguide electrode 112 and the resonator electrode 254. Voltage applied to the coupling electrode 252 can vary refractive index with a space between the waveguide and the resonator defined by the circular electrode 254, thereby varying coupling of light into and out of the resonator. Furthermore, the coupling may be controlled by narrowing waveguide 112 so that the evanescent field is bigger making the coupling through the gap larger. For example, waveguide 112 may be defined using an arrangement of several parallel electrodes, or a plurality of point-like electrodes (as exemplified in FIG. 10). In such configurations, width of the waveguide 112 may be controlled by selection of the number of electrodes defining the waveguide 112. Additionally, selection of electric voltage applied on the resonator electrode 254 may be used to determine and/or fine tune resonance frequency of the resonator and its operation characteristics. In some configurations, an optical resonator, such as formed by resonator electrode 254 may be operable in a photonic circuit as a delay line. In some configurations, the photonic circuit system may include one or more electrodes, or sets of electrodes, configured and positioned to define, when activated with selected electric voltage, a bent or curved waveguide portion to define a delay line in a photonic circuit (e.g., in a shape of a spiral).

A resonator can also be made of a straight waveguide portion with Bragg mirrors at each side forming a Fabry-Perot resonator, whereby the Bragg mirrors are made by modulating the electric field along the axis of the waveguide.

Generally, in some embodiments, the photonic circuit system of the present disclosure may utilize selected photonic structures for various applications. For example, one or more optical resonators may be used as delay lines, frequency filters, narrow linewidth lasers, micro-frequency combs, quantum memory, and various other photonic applications. Additionally, typical waveguide structure may be operable of selected electric voltage, varying the refractive index therein, thereby affecting optical path and phase accumulated by the optical signals transmitted in the photonic circuit.

The electrode arrangement 110 used in the different photonic circuit configurations described herein above may include various electrodes. During operation, selected electrodes may be activated using selected electric voltage to define respective waveguides, coupling between waveguides, phase affecting elements and other optical elements required for operation of a selected photonic circuit. Additionally, elements of the photonic circuit may be changed dynamically by varying electric voltage on the respective electrodes. This may be used for dynamically varying coupling between waveguides, phase variation along selected waveguides or through selected phase elements, operation of selected resonators etc. Accordingly, the photonic circuit system of the present disclosure provides flexibility in circuit design and operation and provides grounds for dynamically varying photonic circuits.

The photonic circuit system 100 according to some embodiments of the present disclosure may be configured to provide increased flexibility in supported photonic circuits. FIG. 10 exemplifies a photonic circuit system 100 according to some embodiments of the present disclosure. The photonic circuit system 100 exemplified in FIG. 10 includes an electrode arrangement 110 located on one facet of at least one photonic layer 50, where an additional one or more electrodes are located on the other facet of the at least one photonic layer 50 and are not specifically shown in FIG. 10. The electrode arrangement 110 is formed of an array of a plurality of electrodes 112. The electrodes 112 are preferably of a dimension not exceeding the wavelength of light used in the photonic circuit 100. This dimension of the electrodes 112 enables operation of a group of two or more electrodes to form together a common waveguide, or common region having effective refractive index within the photonic layer 50. More specifically, operation of two or more electrodes to be in a selected electric voltage V, provides electric field applied on the photonic layer 50 by the two or more electrodes 112. To provide an effectively smooth electric field within the photonic layer, a spacing between the electrodes 112 is preferably selected to be much smaller than wavelength of light used, and preferably in the order of tens on nanometers or below. Accordingly, the different electrodes 112 of electrode arrangement 110 are preferably configured with lateral (x, or y axes) dimension being below wavelength of light used in the photonic circuit. This configuration of the electrodes enables increased flexibility in waveguides structure that can be formed by the electrode arrangement 110, enabling operation of one or more selected groups of electrodes to form together a waveguide arrangement within the photonic layer 50. For example, the electrodes 112 may have width and/or length being below one hundred nanometers, in the case of photonic circuit configures for use in infrared illumination of wavelength of 1550 nm.

Accordingly, the present disclosure provides a photonic circuit system utilizing at least one photonic layer and at least one electrode arrangement positioned to apply electric field on selected regions of the photonic layer. The use of electric field applied by selected electrodes of the electrode arrangement define a selected arrangement of one or more waveguides, where strength of the electric field is used to determine refractive index variation in the respective regions of the photonic layer. In some embodiments, the selected arrangement of one or more waveguides is formed without etching or structural manipulation of the photonic layer.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A photonic circuit system comprising at least one photonic layer formed of a material having selected electro-optic properties, and an arrangement of electrodes positioned on at least two opposite facets of the at least one photonic layer; in response to electric potential applied to one or more electrodes of the arrangement of electrodes, a refractive index varies in a respective region of the at least one photonic layer affected by the one or more electrodes, selectively defining shape and path of one or more photonic waveguides within the at least one photonic layer.

2. The photonic circuit system of claim 1, wherein said electrode arrangement comprises a first electrode located at a first surface of the at least one photonic layer, and an arrangement of a plurality of electrodes located at a second surface of the at least one photonic layer, said first electrode acts as a ground electrode.

3. The photonic circuit system of claim 1, further comprising first and second clad layers located at first and second surfaces of the at least one photonic layer between the at least one photonic layer and the electrode arrangement.

4. The photonic circuit system of claim 1, wherein the electrode arrangement comprises a plurality of electrodes comprising at least one elongated electrode defining at least one possible waveguide to be activated in response to applied electric voltage on the at least one elongated electrode.

5. The photonic circuit system of claim 4, wherein the electrode arrangement comprises at least one coupling/splitting sub-arrangement comprising three or more groups of one or more electrodes, wherein a first and a second groups of electrodes define first and second waveguides in response to electric voltage applied thereto, and a middle group of one or more electrode of the coupling/splitting sub-arrangement defines coupling between the first and second waveguides in response to electric potential applied thereto, thereby generating a selectively variable optical element.

6. The photonic circuit of claim 5, wherein said at least one coupling/splitting sub-arrangement is operable for at least one of coupling, splitting, and switching transmission of optical signals within a photonic circuit.

7. The photonic circuit system of claim 1, wherein the electrode arrangement comprises at least one phase affecting sub-arrangement comprising two or more electrodes positioned to affect refractive index within a common region of the at least one photonic layer; said two or more electrodes comprise a main group of one or more electrodes defining a waveguide within the at least one photonic layer in response to electric voltage applied thereto, and at least one secondary electrode affecting refractive index within the waveguide in response to electric voltage applied thereto, thereby selectively affecting phase accumulated by light passing through the waveguide.

8. The photonic circuit system of claim 1, wherein the electrode arrangement comprises at least one set of electrodes configured to define a resonator waveguide portion.

9. The photonic circuit system of claim 8, wherein said at least one set of electrodes configured to define a resonator waveguide portion comprise one or more electrodes defining a circular resonator waveguide.

10. The photonic circuit system of claim 8, wherein said at least one set of electrodes configured to define a resonator waveguide portion comprise a straight waveguide electrode portion and two or more electrodes configured to vary refractive index at two ends of the straight waveguide electrode portion, thereby defining a straight waveguide portion with Bragg mirrors at each side forming a Fabry-Perot resonator.

11. The photonic circuit system of claim 1, wherein the electrode arrangement comprises at least one set of electrodes arranged to define a bent waveguide portion, defining a delay line within a photonic circuit.

12. The photonic circuit system of claim 1, wherein the electrode arrangement comprises a plurality of independently controlled point-like electrodes positioned on at least one facet of the at least one photonic layer, and wherein applying electric voltage to a set of point-like electrodes along a selected region defines a waveguide within respective region of the at least one photonic layer.

13. The photonic circuit system of claim 1, wherein the selected electro-optic properties comprise Pockels coefficient defining refractive index variation in response to DC electric field.

14. The photonic circuit system of claim 13, wherein said at least one photonic layer comprises a material having at least one Pockels coefficient exceeding 1000 pm/V.

15. The photonic circuit system of claim 1, wherein the at least one photonic layer is formed of BTO (BaTiO₃).

16. The photonic circuit system of claim 1, further comprising a control unit comprising at least one processor and memory circuitry, the control unit is electrically connected to electrodes of the electrode arrangement and configured to selectively apply electric voltage to selected electrodes in accordance with desired photonic circuit layout and operation.

17. The photonic circuit system of claim 1, wherein the electrode arrangement comprises electrodes formed of at least one of: (i) electrodes formed of transparent electrically conducting material, (ii) metallic electrodes, wherein the metallic electrodes are sufficiently thin to eliminate absorbing of light by the metallic electrodes, or (iii) crystalline electrodes.

18. (canceled)

19. (canceled)

20. A method for forming a controllable photonic circuit, the method comprising:
(a) providing at least one photonic layer formed of material having selected electro-optical properties;
(b) applying an electrode arrangement formed of a plurality of electrodes having selected pattern to generate electric field affecting the at least one photonic layer from at least one surface of the at least one photonic layer;
(c) providing electric voltage to one or more selected electrodes of the electrode arrangement, such that the one or more electrodes apply electric field onto respective regions of the at least one photonic layer, thereby defining a selected waveguide arrangement within the at least one photonic layer.

21. The method of claim 20, further comprising, selectively varying electric voltage on one or more selected electrodes for controllably varying coupling between waveguides defined by the waveguide arrangement.

22. (canceled)

23. The method of claim 20, wherein applying the electrode arrangement comprises providing at least one common ground electrode at a first side of the at least one photonic layer and providing an electrode arrangement comprising a plurality of electrodes defining one or more possible photonic circuits at a second side of the at least one photonic layer.

24. (canceled)
